(19) United States
(12) Patent Application Publication
(10) Pub. No.: US 2026/0338502 A1
(43) Pub. Date: Oct. 29, 2026

(54) DEFINED CONFIGURATION OF THERMAL COMPONENT WITHIN THERMOPLASTIC MATRIX

(71) Applicant: Indian Institute of Technology Bombay, Mumbai (IN)

(72) Inventors: Kushal Manoj Soni, Mumbai (IN); Arun G. Krishnan, Mumbai (IN); Sagar Dyandeo Talele, Mumbai (IN); Rupesh Eknath Ghyar, Mumbai (IN); Ravi Bhallamudi, Mumbai (IN)

(21) Appl. No.: 19/697,439

(22) Filed: Jun. 3, 2026

Related U.S. Application Data
(63) Continuation of application No. PCT/IN2024/052328, filed on Dec. 3, 2024.

(30) Foreign Application Priority Data
Dec. 3, 2023 (IN) 202321082174

(51) Int. Cl. F28F 21/06; F28F 13/00

(52) U.S. Cl. CPC F28F 21/06; F28F 2013/006

(57) ABSTRACT

A defined configuration of thermal component within thermoplastic matrix, to achieve a controllable network of smart thermoplastic composites, said configuration comprising: smart thermoplastic composites comprising: a thermoplastic component (12); a thermal component (14) interfacing with said thermoplastic component (12); wherein, the cross-sectional arrangement is such that, the thermal component (14) modified the thermal nature of the thermoplastic component in either its hot-active state or in its cold-active state ensuring that there is a pliable or elastic region of deformation within said thermoplastic component (12) by creating a controlled thermal gradient within a region or volume of interest in said thermoplastic component (12) characterized in that, placement of said thermal component (14) being in accordance with a locus of points such that it is in consonance with localised surface area and volumetric footprint constraints, correlative to localised thermal gradient arrangements.

### RELATED APPLICATIONS

This application claims priority under 35 U.S.C. § 120 to, and is a continuation of, co-pending International Application PCT/IN2024/052328, filed Mar. 12, 2024 and designating the US, which claims priority to IN Application 202321082174, filed Dec. 3, 2023, such IN Application also being claimed priority to under 35 U.S.C. § 119. These IN and International applications are incorporated by reference herein in their entireties.

### FIELD

This invention relates to the field of materials and electro-mechanics.

Particularly, this invention relates to the field of functional materials comprising combinatorial components comprising thermoplastic components and non-thermoplastic components.

More particularly, this invention relates to a deformable combinatorial material.

Specifically, this invention relates to defined configuration of thermal component within thermoplastic matrix.

### BACKGROUND

In engineering, ‘deformation’ refers to change in size or shape of an object. Depending on type of material, size and geometry of the object, and forces applied, various types of deformation may result.

FIG. 1 illustrates a typical stress vs. strain diagram indicating various stages of deformation.

In plastic deformation, the deformation is not undone simply be removing applied force. Soft thermoplastics have a rather large plastic deformation range as do ductile metals.

Ductile materials can sustain large plastic deformations without fracture.

In elastic deformation, the deformation is temporary that can be undone simply by removing applied force. This is self-reversing intrinsic property of a material.

In plastic deformation, the deformation is not undone simply be removing applied force. Thermoplastics with high chain mobility have a rather large plastic deformation range. Temperature induced chain mobility is used in the proposed invention to attain a viscoelastic state that allows for manipulation of the loss and storage modulus of the thermoplastic component. This invention relates to increasing the temperature of thermoplastics in “colder” ambient settings for desired deformation using non-thermoplastic thermal element(s), and inversely, in “hotter” ambient settings, thermal element is used to get the thermoplastic out of the viscoelastic state into a desired high stiffness state.

### SUMMARY

There is a need to invent materials with an extendable plastic deformation range.

There is a need to invent materials which are reformable beyond known plastic ranges and deformable beyond known elastic ranges.

There is a need for defining thermal element/s within a thermoplastic matrix for controlled thermal gradient in thermoplastic for achieving smart composites.

An object of the invention is to provide on-demand re-shapable materials.

Another object of the invention is to provide on-demand re-shapable, re-usable, materials.

Yet another object of the invention is to provide systems and methods for creating and controlling thermal gradient in thermoplastics/smart composites using a thermal component.

Still another object of the invention is to provide systems and methods for arranging one or more thermal element/s within a thermoplastic matrix for controlled thermal gradient in thermoplastics/smart composites.

According to this invention, there is provided a defined configuration of thermal component within thermoplastic matrix, to achieve a controllable network of smart thermoplastic composites, said configuration comprising:
one or more smart thermoplastic composites comprising: at least a thermoplastic component having a first cross-sectional profile; at least a thermal component having a second cross-sectional profile and interfacing with said thermoplastic component wherein, the cross-sectional arrangement is such that, the thermal component modified the thermal nature of the thermoplastic component in either its hot-active state or in its cold-active state ensuring that there is a pliable or elastic region of deformation within said thermoplastic component by creating a controlled thermal gradient within a region or volume of interest in said thermoplastic component
an energy source configured to enable transmission of energy between said thermal component and said thermoplastic component; and
an energy sink configured to enable absorption of energy between said thermal component and said thermoplastic component;
a control mechanism configured to achieve a pliable region of deformation, within said thermoplastic component, upon receipt of said transmitted energy, by creating a controlled thermal gradient within a region or volume of interest in said thermoplastic component; wherein placement of said thermal component being in accordance with a locus of points such that it is in consonance with localised surface area and volumetric footprint constraints, correlative to localised thermal gradient arrangements, in a manner that:
temperature distribution throughout the thermoplastic is between its softening point and its viscous point if displacement of the thermal component with respect to thermoplastic due to melting is not desired;
heat flux at external energy vector interaction on the thermoplastic surfaces, should not cause a steady state temperature of more than the viscous point of the said thermoplastic;
thermal gradient in desired region/volume of the interest in the thermoplastic should be in the desired range such that the variance of stiffness between the source and the sink surfaces should not cause cracks/fractures in deforming [low stiffness] state when acted upon the relevant forces;
thermal gradient in desired region/volume of the interest in the thermoplastic should be in the desired range such that the variance of stiffness between the source and the sink surfaces should not cause undesired deformation in its normal functional/intended use case;
for a given section of the volume of interest of the thermoplastic, the number of thermal components is determined by the heat required for the desired temperature distribution, for the given maximum distance between the thermal component and the ambient environment/entity in the said plane.

In at least an embodiment, said defined configuration being selectable from a group of configurations consisting of:
linear configuration achieved by positioning the thermal component in a straight or curvilinear form within the thermoplastic material, so that localized heat and stiffness changes along a linear path,
planar configuration achieved by the thermal component being laid out in a flat, two-dimensional, configuration within the thermoplastic material, so that heat distribution and stiffness changes across a surface area as desired,
spatial configuration achieved by the thermal component being configured in a multi-dimensional manner, so that precise control of thermal gradients and stiffness in three dimensions is achieved,
geometric configuration achieved by grids, spirals, or concentric circles with respect to the thermoplastic component, so that specific thermal profiles and stiffness changes are achieved,
serpentine configuration achieved by winding or meandering pattern for the thermal component, so that controlled, continuous variations in temperature and stiffness along the length of the thermal component are achieved,
concentrated configuration achieved by densely packing thermal components in specific areas,
distributed configuration achieved by distributing thermal components over an area, and
variable configuration achieved by spatial configuration of the thermal component being adjusted or controlled by localised melting of the thermoplastic for modifying the arrangement, allowing for dynamic changes in the thermal gradient and stiffness as needed.

In at least an embodiment, said localised thermal gradient arrangements being selected from a group of arrangements consisting of:
segmented thermal components achieved by dividing said composite into segments, each with its dedicated thermal component, where temperature/s can be independently controlled,
nested thermal components achieved by placing thermal component within one another to create a localized gradient with varying temperature levels,
heat conduction paths achieved by designing specific heat conduction paths within the material, where heat travels to create localised temperature variations,
contoured heaters achieved by customising shape and arrangement of thermal component to match desired temperature profile/s or gradient/s in three dimensions,
variable thermal mass achieved by manipulating local density of the thermoplastic, in specific regions, to control thermal retention and achieve localised thermal gradients,
localised enclosures achieved by localised enclosures or compartments may be created within the thermoplastic material where thermal components are placed, ensuring distinct thermal zones, and
intermittent thermal components achieved by arranging thermal components, intermittently, or in a pattern, creating alternating regions of heated and unheated areas and, conversely, cooled and uncooled areas; alternating regions of thermal variance.

In at least an embodiment, one or more thermal components being ensconced, partially or fully, in a spaced apart manner within said thermoplastic component, the two or more thermal components being parallel to one another or being located in a pre-defined pattern in the thermoplastic component.

In at least an embodiment, one or more thermal components being ensconced, partially or fully, within a thermoplastic component, the one or more thermal components having uniform cross-section throughout its traverse.

In at least an embodiment, one or more thermal components being ensconced, partially or fully, within a thermoplastic component, the one or more thermal components having tapering cross-section throughout its traverse.

In at least an embodiment, one or more thermal components being ensconced, partially or fully, within a thermoplastic component, the one or more thermal components having variable cross-section throughout its traverse.

In at least an embodiment, the cross-sectional arrangement is such that, the thermal component modified the thermal nature of the thermoplastic component in either its hot-active state or in its cold-active state ensuring that there is a pliable or elastic region of deformation within said thermoplastic component by creating a controlled thermal gradient within a region or volume of interest in said thermoplastic component by:
increasing localised temperature, of said thermoplastic component, above its softening point but below its viscous temperature in hot-active state; and maintaining ambient temperature above its softening point and
maintaining localised temperature below its softening point in cold-active state.

In at least an embodiment, said control mechanism configured to achieve a pliable region of deformation, within said thermoplastic component, upon receipt of said transmitted energy, by creating a controlled thermal gradient within a region or volume of interest in said thermoplastic component, by:
controlling said transmission of energy in a first chosen unidirectional manner and to control said absorption of energy in a second chosen unidirectional manner, each of said first chosen unidirectional manner and said second chosen unidirectional manner never being the same direction;
controlling said transmission of energy between a viscous point of said thermoplastic component and a softening point of said thermoplastic component.

In at least an embodiment, said interfacing is selecting from a group of interfacing types selected from thermal interfacing, physical interfacing, partial interfacing, completely ensconced interfacing with the thermoplastic component completely ensconcing the thermal component, completely ensconced interfacing with the thermal component completely ensconcing the thermoplastic component, partially ensconced interfacing with the thermoplastic component partially ensconcing the thermal component, partially ensconced interfacing with the thermal component partially ensconcing the thermoplastic component.

In at least an embodiment, said thermoplastic being activated in its hot active mode of working, in that, energy control, vide a control mechanism, from an energy source to an energy sink being controlled such that thermoplastic temperature (Tt) being more than thermoplastic viscous temperature (Tv/Tm) but being less than thermoplastic softening temperature (Tg).

In at least an embodiment, said thermoplastic being activated in its hot active mode of working, in that, energy control, vide a control mechanism, from an energy source to an energy sink being controlled such that temperature (Tsource) of said energy source being greater than or equal to temperature (Tth) of said thermal component, temperature (Tth) of said thermal component being greater than or equal to temperature (Ttp) of said thermoplastic component, temperature (Ttp) of said thermoplastic component being greater than or equal to temperature (Tsink) of said energy sink.

In at least an embodiment, said thermoplastic being activated in its cold active mode of working, in that, energy control, vide a control mechanism, from an energy sink to an energy source being controlled such that thermoplastic temperature (Tt) being more than thermoplastic softening temperature (Tg) but being less than thermoplastic viscous temperature (Tv/Tm).

In at least an embodiment, said thermoplastic being activated in its cold active mode of working, in that, energy control, vide a control mechanism, from an energy sink to an energy source being controlled such that temperature (Tsource) of said energy source being lesser than or equal to temperature (Tth) of said thermal component, temperature (Tth) of said thermal component being lesser than or equal to temperature (Ttp) of said thermoplastic component, temperature (Ttp) of said thermoplastic component being lesser than or equal to temperature (Tsink) of said energy sink.

In at least an embodiment, said thermal component, being a non-thermoplastic component, acting as an internal thermal source.

In at least an embodiment, said thermal component, being a non-thermoplastic component, composed of a polar compound or a dielectric material, when intercepted by electromagnetic radiation of corresponding frequency, acting as a heat source.

In at least an embodiment, said thermal component, being a non-thermoplastic component, which is in thermal contact with an external heat source and said thermoplastic component.

In at least an embodiment, for said thermal component acting as an energy source, said control mechanism configured to achieve a pliable region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be greater than or equal to 1.

In at least an embodiment, for said thermal component acting as an energy sink, said control mechanism configured to achieve a elastic region of deformation, within said thermoplastic component, upon receipt of said transmitted energy, by creating a controlled thermal gradient within a region or volume of interest in said thermoplastic component, by: maintaining ratio (V_{E}) of loss modulus, of said thermoplastic component to storage modulus of said thermoplastic component be lesser than 1.

### BRIEF DESCRIPTION OF THE ACCOMPANYING DRAWINGS

FIG. 1 illustrates a typical stress vs. strain diagram indicating various stages of deformation.

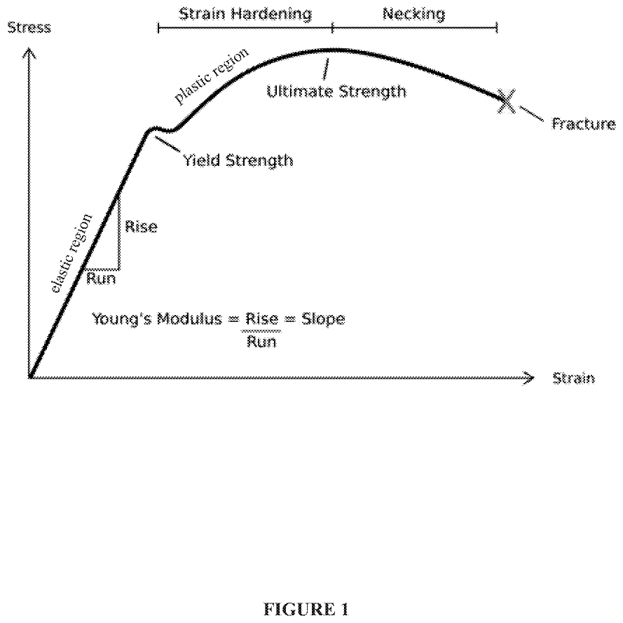

The invention will now be described in relation to the accompanying drawings, in which:

FIG. 2 illustrates a schematic block diagram for the smart thermoplastic composite of this invention.

FIG. 3 illustrates a linear arrangement as one of the defined configurations of the thermal component (14) within the thermoplastic matrix (12);

FIG. 4 illustrates a planar arrangement as one of the defined configurations of the thermal component (14) within the thermoplastic matrix (12); and

FIG. 5 illustrates an embodiment showing various spatial arrangements as various defined configurations of the thermal component (14) within the thermoplastic matrix (12).

### DETAILED DESCRIPTION

According to this invention, there is provided a defined configuration of thermal component within thermoplastic matrix.

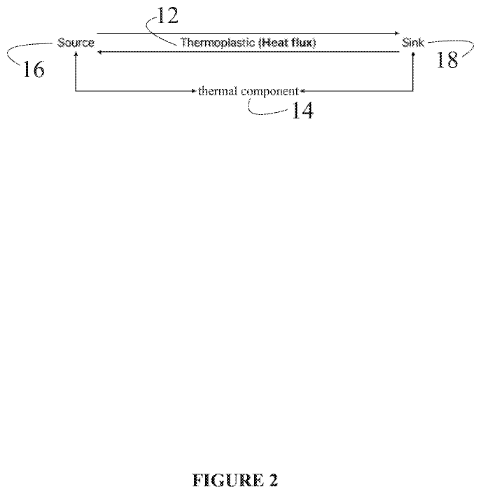

FIG. 2 illustrates a schematic block diagram for the smart thermoplastic composite of this invention.

In at least an embodiment, the present invention concerns a composite material or a combinatorial material, particularly being a smart composite, comprising at least a thermoplastic component (12) and at least a thermal component (14) coupled with the thermoplastic component (12). Additionally, the present invention concerns a composite material or a combinatorial material, particularly being a smart composite, comprising at least an energy source (16) and an energy sink (18).

For the purposes of this invention, viscous point of given thermoplastic is defined as a temperature at which the loss modulus of the thermoplastic is such that the displacement of the thermal element may occur due to the thermally induced viscosity in the thermoplastic. Whereas, the softening point of the given thermoplastic is defined as a temperature at which the loss modulus becomes equal to storage modulus, thereby becoming pliable. The ratio of loss modulus and storage modulus is defined as VE.

The placement of the thermoplastic component (12) and the thermal component (14), with respect to each other, is such that thermal energy should be passed from one to the other in a uni-directional or bidirectional manner, the passing may be in the form of conduction, convection, and/or radiation.

In at least an embodiment, the thermal component (14), being a non-thermoplastic component, acts as an internal thermal source that works on the basis of Ohmic heating (using a resistance wire) or Thermoelectric heating (using a Thermocouple). Electric current for the thermal element generates heat for these by eddy currents due to electromagnetic induction or electric current directly supplied to the conductor by conduction. this configuration facilitates ‘electric heating.’

In at least an embodiment, the thermal component (14), being a non-thermoplastic component, which can be composed of a polar compound or a dielectric material, when intercepted by electromagnetic radiation of the corresponding frequency, this acts as a heat source. One of the embodiments of this configuration can be a channel in the volume of the thermoplastic, filled with this thermal element. Another embodiment of the same can be a thermal component scattered throughout the volume of the thermoplastic in the form of a suspended additive. This configuration facilitates ‘heating by way of electromagnetic radiation.’

In at least an embodiment, the thermal component (14), being a non-thermoplastic component, which is in thermal contact with an external heat source and the thermoplastic. In such a configuration the thermal component acts as a conductor between a heat source by transferring the heat from the external heat source to the thermoplastic. This configuration facilitates ‘contact heating.’

In at least an embodiment, the source (16) passes energy to the thermal component.

In some embodiments, shape memory materials may be used, as a thermal component (15), that can apply a force on the thermoplastic component at particular temperatures and even be trained at other temperatures. Properties and characteristics of such materials need to be considered:
Martensitic Transformation Temperature
Austenitic Transformation Temperature
Hysteresis Width (ΔT)
Degree of Deformation
Programming temperature (Shape memory polymers)
Recovery Temperature

Additionally, non-contact forces may also act on the composite, the non-contact forces being:
Gravity may be used to use the weight acting on the volume of interest in the composite;
Magnetic field acting on the composite;
Static electric forces acting on the composite.

In some embodiments, combination of externally acting contact forces may be used to deform or hold a form of the combined composite of this invention.

In some embodiments, combination of contact and non-contact forces may be used to deform or hold a form of the combined composite of this invention.

Particularly, this invention outlines systems and methods for strategically routing and arranging one or more thermal components/elements [14] in conjunction with a thermoplastic component [12] to achieve a smart composite having a thermoplastic component [12], a thermal component [14], a source [16], and a sink [18].

Specifically, the proposed invention is a system and method for thermal component routing and arrangement with a thermoplastic element based on the functional requirements, energy delivery, and control mechanisms intended for creating a controlled thermal gradient between the thermal component [14], and the ambient environment/entity through a thermoplastic [12] acting as a thermal conductor, such that heat flux between the source (16) and the sink (18) allows for a change in stiffness of the thermoplastic [12] as desired.

Across multiple embodiments, various arrangements are configured to tailor and meet specific functional requirements for applications of this invention's composite and to accommodate energy delivery and control mechanisms for the thermal component [14]. The control mechanism establishes a precisely controlled thermal gradient between the thermal component [14] and the surrounding ambient environment or entity. This gradient is achieved through the thermoplastic material, which serves as a thermal conductor, facilitating transfer of heat between the source (16) and the sink (18). The result of this controlled heat flux is the desired alteration in the stiffness of the thermoplastic material, to meet specific needs of desired applications.

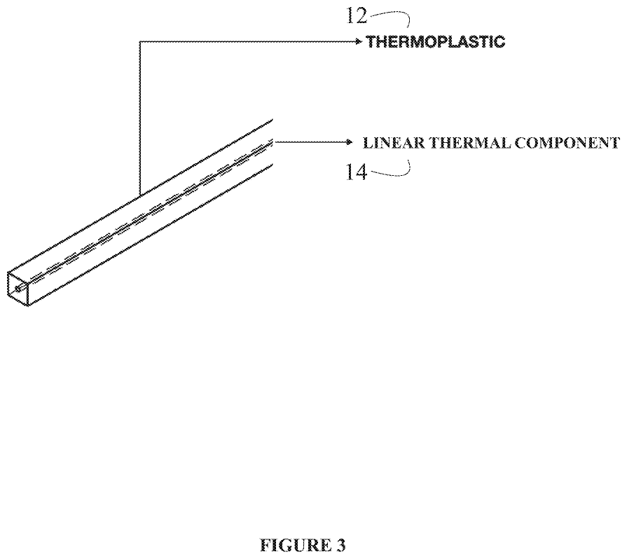

FIG. 3 illustrates a linear arrangement as one of the defined configurations of the thermal component (14) within the thermoplastic matrix (12).

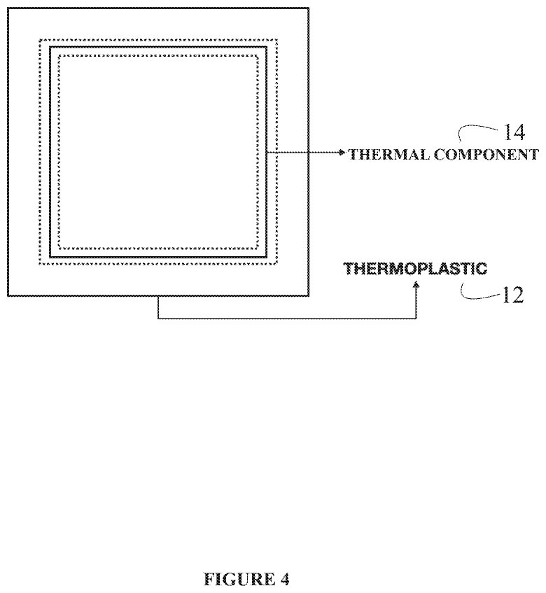

FIG. 4 illustrates a planar arrangement as one of the defined configurations of the thermal component (14) within the thermoplastic matrix (12).

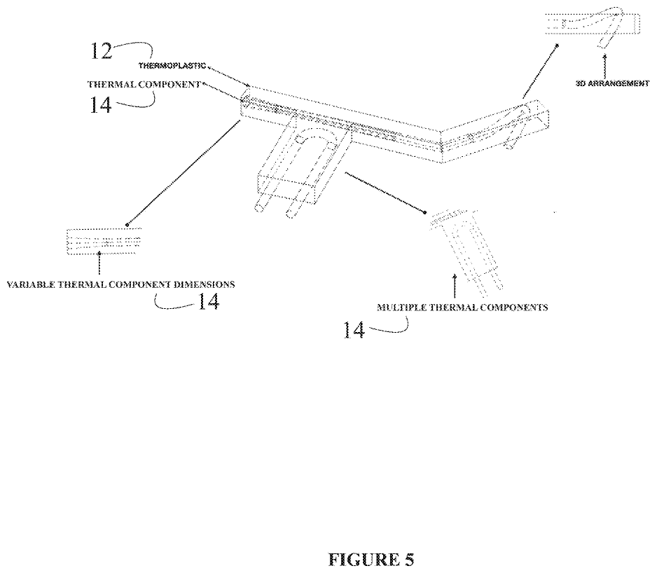

FIG. 5 illustrates an embodiment showing various spatial arrangements as various defined configurations of the thermal component (14) within the thermoplastic matrix (12).

In at least an embodiment, placement of thermal component (14) is in accordance with a locus of points such that it is in consonance with localised surface area and volumetric footprint constraints/requirements in a manner that:
temperature distribution throughout the thermoplastic (12) should be between its softening point and its viscous point if displacement of the thermal component (12) with respect to thermoplastic due to melting is not desired;
heat flux at external energy vector interaction point (e.g. electric terminals for a resistive heat core, couplings for pressure based heating) on the thermoplastic surfaces, should not cause a steady state temperature of more than the viscous point of the said thermoplastic;
thermal gradient in desired region/volume of the interest in the thermoplastic should be in the desired range such that the variance of stiffness between the source and the sink surfaces should not cause cracks/fractures in deforming [low stiffness] state when acted upon the relevant forces;
thermal gradient in desired region/volume of the interest in the thermoplastic (12) should be in the desired range such that the variance of stiffness between the source and the sink surfaces should not cause undesired deformation in its normal functional/intended use case;
for a given section of the volume of interest of the thermoplastic (12), the number of thermal components (14) is determined by the heat required for the desired temperature distribution, for the given maximum distance between the thermal component (14) and the ambient environment/entity in the said plane.

In at least an embodiment, dimensions and geometry of the thermal component (14) is such that stiffness of the combination of the thermal component (14) and the thermoplastic (12), as a function of thermal gradient, and energy acting upon the thermal component (14), are used for determining dimensions and geometry of the thermal component (14). This is essential for arranging the thermal component (14) and the thermoplastic (12) compatible with control mechanisms, protocols, algorithms, open/closed loop systems, and the like. The flexural, tensile, compressive moduli, at various temperature gradients, in the thermoplastic (12) may be determined using Dynamic Mechanical Analysis of a given combination of the thermoplastic (12) and the thermal component (14) in a combined embodiment.

Amplitude sweep, Frequency sweep and temperature sweep may be used to assess the rheological and viscoelastic properties (loss modulus and storage modulus) of the thermoplastic at various temperatures and heat rates.

In at least an embodiment, placement of the thermoplastic(s) (12) and the thermal components (14) should be optimised for reactive forces at a junction of these to not cause cracking, failure, fracture during the desired forming operation and/or due to the action of non-contact forces like:
Gravity may be used to use the weight acting on the volume of interest in the embodiment.
Magnetic field acting on the embodiment
Static electric forces acting on the embodiment

In at least an embodiment, spatial arrangements can be selected from a group of spatial arrangements consisting of:
1. Linear Arrangement: A linear arrangement involves positioning the thermal component (14) in a straight or curvilinear form within the thermoplastic material (12). This is beneficial when creating localized heat and stiffness changes along a linear path.
2. Planar Arrangement: In a planar arrangement, the thermal component (14) is laid out in a flat, two-dimensional, configuration within the thermoplastic material (12). This arrangement can be used when particular heat distribution and stiffness changes across a surface are desired.
3. Spatial Arrangement: In a spatial arrangement, the thermal component (14) is configured in a multi-dimensional (preferably, 3D) manner, often as a complex structure. This arrangement is employed when precise control of thermal gradients and stiffness in three dimensions is required.
4. Geometric Patterns: Spatial arrangements can also include use of geometric patterns, such as grids, spirals, or concentric circles with respect to the thermoplastic matrix (12). These patterns are strategically designed to create specific thermal profiles and stiffness changes within the material.
5. Serpentine Arrangements: A serpentine arrangement involves a winding or meandering pattern for the thermal component (14). It can be used for achieving controlled, continuous variations in temperature and stiffness along the length of the thermal component (14).
6. Concentrated and Distributed Arrangements: Depending on the application, spatial arrangements can be concentrated, meaning thermal component (14) are densely packed in specific areas, or distributed more evenly throughout the material.
7. Variable Arrangements: Variable arrangements involve designs where the spatial configuration of the thermal component (14) can be adjusted or controlled by localised melting of the thermoplastic (12) for modifying the arrangement, allowing for dynamic changes in the thermal gradient and stiffness as needed. This is beneficial in systems where conditions change over time.

In at least an embodiment, localised thermal gradient arrangements can be selected from a group of arrangements consisting of:
1. Segmented Thermal Components: Dividing the material into segments, each with its dedicated thermal component (14), where temperature/s can be independently controlled.
2. Nested Thermal Components: Placing thermal component (14) within one another to create a localized gradient with varying temperature levels.
3. Heat Conduction Paths: Designing specific heat conduction paths within the material, where heat travels to create localised temperature variations.
4. Contoured Heaters: Customising the shape and arrangement of thermal component (14) to match desired temperature profile/s or gradient/s in three dimensions.
5. Variable Thermal Mass: Manipulating local density of the thermoplastic (12), in specific regions, to control thermal retention and achieve localised thermal gradients.
6. Localised Enclosures: Localised enclosures or compartments may be created within the thermoplastic material (12) where thermal components (14) are placed, ensuring distinct thermal zones.
7. Intermittent Thermal Components: Arranging thermal components, intermittently, or in a pattern, creating alternating regions of heated and unheated areas and, conversely, cooled and uncooled areas; basically alternating regions of thermal variance.

The energy vector for the heat flow control may act on the thermal component via appropriate techniques such as deterministic energy interaction points (e.g. terminals for electric current, thermally conductive paths for external heat source/sink, controlled exposure to electromagnetic radiation for radiative heat transfer, et cetera)

In at least an embodiment, using this invention, desired sequential localised loading for programmed/logical intrinsic deformation, of the smart composite of this invention, can be achieved by creating viscoelastic boundaries in the thermoplastic component where the V_{E}=1.0:
distribution of plurality of thermal components (14) throughout the composite matrix, with corresponding energy external control vector or plurality of such components;
linear, planar, and spatial temperature gradients can be created within a thermal component (14) to achieve this (e.g. High thermal resistance thermoplastics);
desired control variability with respect to space and time, responsiveness, mechanical fatigue, heat transfer rate with the ambient environment/entity(s).

In at least an embodiment, using this invention, desired sequential localised loading for programmed/logical intrinsic deformation, of the smart composite of this invention, can be achieved by:
distribution of plurality of thermal components (14) throughout the composite matrix, with corresponding energy external control vector or plurality of such;
linear, planar, and spatial temperature gradients (with respect to time) can be created within a thermal component (14) to achieve this (e.g. High thermal resistance materials);
desired control variability with respect to space and time, responsiveness, mechanical fatigue, heat transfer rate with the ambient environment/entity(s).

In at least an embodiment, two or more thermal components (14) may be ensconced/partially enclosed in a spaced apart manner within a thermoplastic component (12), the two or more thermal components (14) being parallel to one another or being located in a pre-defined pattern in the thermoplastic component (12).

In at least an embodiment, one or more thermal components (14) may be ensconced/partially enclosed within a thermoplastic component (12), the one or more thermal components (14) having uniform cross-section throughout its traverse.

In at least an embodiment, one or more thermal components (14) may be ensconced/partially enclosed within a thermoplastic component (12), the one or more thermal components (14) having tapering cross-section throughout its traverse.

In at least an embodiment, one or more thermal components (14) may be ensconced/partially enclosed within a thermoplastic component (12), the one or more thermal components (14) having variable cross-section throughout its traverse.

While the present composite specification describes various heat transfer methods from/through a thermal component, it may be obvious to a person skilled in the art that the thermal component may use any known heat transfer mechanisms and their combinations to achieve a controlled thermal gradient in a thermoplastic for achieving V_{E}<1 in cold environments and conversely, cool it in hot environments to achieve V_{E}≥1; allowing the thermoplastic component to exhibit a manipulated deformation, into a desired geometry upon application of force(s) or stress(es).

While the present composite specification describes various heat transfer methods from/through a thermal component, it may be obvious to a person skilled in the art that the thermal component may use any known heat transfer mechanisms and their combinations to achieve a controlled thermal gradient in a thermoplastic for glass transition in cold environments and conversely, cool it in hot environments; allowing the thermoplastic component to exhibit a manipulated deformation, into a desired geometry upon application of force(s) or stress(es).

TECHNICAL ADVANTAGES: There are limited solutions for on-demand re-shapable materials; Thermoplastic casts, helmets, supports, splints, braces, due to their high stiffness provide higher amount of rigidity than plaster-based supports which allows the invention to have a relatively less volumetric footprint and also weigh less.

Thermoplastics are immune to the effects of everyday liquids like alcohols, oils, waters, detergents, soaps, milks and carbonated waters; thus, it allows the patient to be oblivious to everyday liquid spills thus also allowing the patient to safely and comfortably observe daily hygiene;

Using thermoplastic in the form of a mesh/grid decreases the amount of material and thereby the cost, to an extent where it is economically competitive with the ubiquitously used plaster and fiberglass composites; The configuration of the invention allows it to have lower net skin surface coverage than that of the relevant region it is applied upon and is therefore very comfortable for the patient's skin-it lets the skin be exposed to air and reduces the risk of dermal complications and irritations substantially; The smooth and inert inner layer eliminates the need for padded wrappings; An internal heat source is implemented in the volume of the thermoplastic mesh or (regions of the thermoplastic mesh) and is controlled by an external vector to raise the temperature of the mesh/part of the mesh to a range between the Glass Transition and the Melting points of the material in optimal time. The regions where these heat sources are implemented are essentially morphable, once the desirable temperature is attained. This thermosoftening nature of the material together allows these particular region(s) to become flexible upon the will of the personnel controlling the external vector, so as to be wrapped, applied and shaped as desired for the orthotic therapy; The mesh may be preformed and modified by the medical personnel as desired for individual cases before being used as an orthosis; The internal heat source allows the device to be removable and even reusable; The thermosoftening mechanism eliminates the use of crude tools for the orthosis application and removal process; Adjustability and the versatility of the morphable regions of the mesh reduces risk of compressive soft tissue injury, pressure sores, etc.; Ease of application—Pre-assembly and the rapid polymer re-crystallization after glass transition reduces lengthy complicated application procedures common in all encasing bandage/fiber based conventional orthopedic casting solutions and the custom fit orthosis like corrective helmet.

### Non-Limiting Exemplary Use-Cases

Solution for skin problems: The absolute coverage of affected regions under thick and hard materials such as plaster slabs, fiberglass, polymer helmets triggers skin irritation and dermal conditions like dermatitis, pressure sores and ulcers. This invention solves these problems.

Solution for high application and molding time: Plaster and fiberglass orthoses require a substantial amount of effort and time. It takes time in orders of up to tens of minutes for the conventional fiberglass and plaster-based orthoses to be applied, molded and completely cured. The job of making thermoplastic prosthetic leg attachments and orthotic calipers is also quite tedious requiring long man hours. Whereas devices like deformation correction helmets require days to be tailor made for the patient. This invention solves these problems.

Solution for high volume and footprint: Plaster slabs inherently have very high volume and weight which makes the daily functions of the patient more difficult who are already in discomfort. This invention solves these problems.

Solution for fragility: Plaster-based fracture casts are prone to breakage and also cannot retain their integrity in case of direct interaction with everyday liquids like alcohols, oils, water, detergents, soaps, milks and carbonated drinks. Fiberglass casts are also only partially resistant to water and other daily life liquids. This invention solves these problems.

Solution for high costs: Fiberglass casts that provide a certain degree of water resistance and higher strength are considerably expensive as compared to Plaster casts and not affordable to many. Repeat costs of single-use devices, devices that are not accommodative of growth. This invention solves these problems.

While the invention was developed for external orthopedic immobilization, it may be used very easily for various other applications such as customized chairs, shoes, morphable airfoils in aircraft, etc. The constructive combination of a thermoplastic with a second material acting as a respective heat source to enable on-demand thermosoftening of the thermoplastic can be easily used in various forms. this invention solves these problems.

The TECHNICAL ADVANCEMENT, of this invention, lies in providing a smart composite material such that it achieves strategically routing and arranging a thermal component in conjunction with a thermoplastic component. The arrangement is tailored to meet specific functional requirements for application of such a composite and to accommodate energy delivery and control mechanisms for the thermal component. The control mechanism establishes a precisely controlled thermal gradient between the thermal component and the surrounding ambient environment or entity. This gradient is achieved through the thermoplastic material, which serves as a thermal conductor, facilitating the transfer of heat between the heat source and the heat sink. The result of this controlled heat flux is the desired alteration in the stiffness of the thermoplastic material, to meet specific needs of the desired applications.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A defined configuration of thermal component within thermoplastic matrix, to achieve a controllable network of smart thermoplastic composites, the configuration comprising:
one or more smart thermoplastic composites including,
a thermoplastic component having a first cross-sectional profile, and
a thermal component having a second cross-sectional profile and interfacing with the thermoplastic component, the thermal component being structurally coupled to the thermoplastic component such that a controlled thermal gradient is established within a region or volume of interest of the thermoplastic component;
an energy source structurally coupled to the thermal component and configured to transmit energy to the thermal component;
an energy sink structurally coupled to the thermal component on a side opposing the energy source and configured to absorb energy from the thermal component;
a control mechanism operably coupled to the energy source and the energy sink and configured to establish a pliable region of deformation within the thermoplastic component by controlling transmission and absorption of energy through the thermal component, thereby creating a controlled thermal gradient within a region or volume of interest in the thermoplastic component, in either a hot-active state or a cold-active state, wherein the thermal component is positioned within the thermoplastic component in accordance with a locus of points correlative to localised surface area and volumetric footprint constraints, such that,
the thermal component is arranged within the thermoplastic component such that a thermal gradient established therebetween maintains a temperature distribution of the thermoplastic component between its softening point and its viscous point, where displacement of the thermal component relative to the thermoplastic component due to melting is not desired,
the energy source is configured such that heat flux at an interface between the energy source and the thermoplastic component does not establish a steady-state temperature exceeding the viscous point of the thermoplastic component;
the thermal component is arranged such that a stiffness variance between a source-side surface and a sink-side surface of the thermoplastic component, in the pliable state, does not cause fracture or cracking of the thermoplastic component under applied deforming forces,
the thermal component is further arranged such that the stiffness variance does not cause undesired deformation of the thermoplastic component during normal functional use, and
a number of the one or more thermal components is determined in accordance with a heat requirement for achieving a desired temperature distribution, for a given maximum distance between the thermal component and an ambient environment within a cross-sectional plane of the thermoplastic component.

2. The configuration of claim 1, wherein the thermal component is positioned within the thermoplastic component in a configuration selected from the group consisting of:
a linear configuration, wherein the thermal component is positioned in a straight or curvilinear form within the thermoplastic component, such that localised heat and stiffness changes are established along a linear path;
a planar configuration, wherein the thermal component is laid out in a flat, two-dimensional arrangement within the thermoplastic component, such that heat distribution and stiffness changes are established across a surface area;
a spatial configuration, wherein the thermal component is arranged in a multi-dimensional manner within the thermoplastic component, such that thermal gradients and stiffness are controllable in three dimensions
a geometric configuration, wherein the thermal component is arranged in a pattern selected from grids, spirals, and concentric circles within the thermoplastic component, such that specific thermal profiles and stiffness changes are established;
a serpentine configuration, wherein the thermal component is arranged in a winding or meandering pattern within the thermoplastic component, such that continuous variations in temperature and stiffness are established along the length of the thermal component;
a concentrated configuration, wherein a plurality of the thermal components are densely packed within specific areas of the thermoplastic component;
a distributed configuration, wherein a plurality of the thermal components are distributed over an area of the thermoplastic component; and
a variable configuration, wherein the spatial arrangement of the thermal component is adjustable by localised melting of the thermoplastic component, such that dynamic changes in the thermal gradient and stiffness of the thermoplastic component are achievable.

3. The configuration of claim 1, wherein the localised thermal gradient is established by a localised thermal gradient arrangement selected from the group consisting of:
segmented thermal components, wherein the thermoplastic component is divided into segments each having a dedicated thermal component, such that temperature of each segment is independently controllable;
nested thermal components, wherein one or more thermal components are placed within one another within the thermoplastic component, creating a localised gradient with varying temperature levels;
heat conduction paths, wherein specific heat conduction paths are defined within the thermoplastic component, such that heat travels along the paths to create localised temperature variations;
contoured thermal components, wherein the shape and arrangement of the thermal component are configured to match a desired temperature profile or gradient in three dimensions within the thermoplastic component;
variable thermal mass, wherein the local density of the thermoplastic component is varied in specific regions to control thermal retention and achieve localised thermal gradients;
localised enclosures, wherein enclosures or compartments are defined within the thermoplastic component and the thermal components are placed therein, establishing distinct thermal zones; and
intermittent thermal components, wherein the thermal components are arranged intermittently or in a pattern within the thermoplastic component, creating alternating regions of heated and unheated areas and alternating regions of cooled and uncooled areas.

4. The configuration of claim 1, wherein two or more thermal components are at least partially enclosed within the thermoplastic component in a spaced-apart manner, the two or more thermal components being arranged parallel to one another or in a pre-defined pattern within the thermoplastic component.

5. The configuration of claim 1, wherein one or more thermal components are at least partially enclosed within the thermoplastic component, the one or more thermal components having a uniform cross-section throughout their traverse within the thermoplastic component.

6. The configuration of claim 1, wherein one or more thermal components are at least partially enclosed within the thermoplastic component, the one or more thermal components having a tapering cross-section throughout their traverse within the thermoplastic component.

7. The configuration of claim 1, wherein one or more thermal components are at least partially enclosed within the thermoplastic component, the one or more thermal components having a variable cross-section throughout their traverse within the thermoplastic component.

8. The configuration of claim 1, wherein the thermal component modifies the thermal nature of the thermoplastic component in either a hot-active state or a cold-active state by:
increasing a localised temperature of the thermoplastic component above its softening point but below its viscous point in the hot-active state; and
maintaining an ambient temperature above the softening point of the thermoplastic component while maintaining a localised temperature of the thermoplastic component below the softening point in the cold-active state.

9. The configuration of claim 1, wherein the thermoplastic component is activated in a hot-active mode, wherein the control mechanism controls energy transmission from the energy source to the energy sink such that a temperature of the thermoplastic component is greater than the softening temperature of the thermoplastic component and less than the viscous temperature of the thermoplastic component.

10. The configuration of claim 1, wherein the thermoplastic component is activated in a hot-active mode, wherein the control mechanism controls energy transmission from the energy source to the energy sink such that:
a temperature of the energy source is greater than or equal to a temperature of the thermal component;
the temperature of the thermal component is greater than or equal to a temperature of the thermoplastic component; and
the temperature of the thermoplastic component is greater than or equal to a temperature of the energy sink.

11. The configuration of claim 1, wherein the thermoplastic component is activated in a cold-active mode, wherein the control mechanism controls energy absorption from the energy sink to the energy source such that a localised temperature of the thermoplastic component is less than the softening temperature of the thermoplastic component, while an ambient temperature surrounding the thermoplastic component is greater than the softening temperature.

12. The configuration of claim 1, wherein the thermoplastic component is activated in a cold-active mode, wherein the control mechanism controls energy absorption from the energy sink to the energy source such that:
a temperature of the energy source is less than or equal to a temperature of the thermal component;
the temperature of the thermal component is less than or equal to a temperature of the thermoplastic component; and
the temperature of the thermoplastic component is less than or equal to a temperature of the energy sink.

13. The configuration of claim 1, wherein the control mechanism is configured to establish the controlled thermal gradient by:
controlling transmission of energy from the energy source to the thermal component in a first chosen unidirectional manner; and
controlling absorption of energy from the thermal component to the energy sink in a second chosen unidirectional manner, the first chosen unidirectional manner and the second chosen unidirectional manner being different directions, wherein the control mechanism controls the transmission of energy such that a temperature of the thermoplastic component is maintained between the softening point and the viscous point of the thermoplastic component.

14. The configuration of claim 1, wherein the interfacing between the thermal component and the thermoplastic component is selected from the group consisting of:
thermal interfacing
physical interfacing;
partial interfacing;
completely ensconced interfacing wherein the thermoplastic component completely encloses the thermal component;
completely ensconced interfacing wherein the thermal component completely encloses the thermoplastic component;
partially ensconced interfacing wherein the thermoplastic component partially encloses the thermal component; and
partially ensconced interfacing wherein the thermal component partially encloses the thermoplastic component.

15. The configuration of claim 1, wherein the thermal component is a non-thermoplastic component configured to act as an internal thermal source within the thermoplastic component.

16. The configuration of claim 1, wherein the thermal component is a non-thermoplastic component composed of a polar compound or a dielectric material, the thermal component being configured to act as a heat source upon interception by electromagnetic radiation of a corresponding frequency.

17. The configuration of claim 1, wherein the thermal component is a non-thermoplastic component in thermal contact with an external heat source and with the thermoplastic component, the thermal component being configured to conduct heat from the external heat source to the thermoplastic component.

18. The configuration of claim 1, wherein for the thermal component acting as the energy source, the control mechanism is configured to maintain a ratio of loss modulus to storage modulus of the thermoplastic component at greater than or equal to 1, thereby establishing a pliable region of deformation within the thermoplastic component.

19. The configuration of claim 1, wherein, for the thermal component acting as the energy sink, the control mechanism is configured to maintain a ratio of loss modulus to storage modulus of the thermoplastic component at less than 1, thereby establishing an elastic region of deformation within the thermoplastic component.
